(19) United States
(12) Patent Application Publication
(10) Pub. No.: US 2004/0142603 A1
(43) Pub. Date: Jul. 22, 2004

(54) Attachable modular electronic systems

(76) Inventor: J. Thomas Walker, Frederick, MD (US)

Correspondence Address: KENYON & KENYON, 1500 K STREET, N.W., SUITE 700, WASHINGTON, DC, 20005, US

(21) Appl. No.: 10/625,552

(22) Filed: Jul. 24, 2003

Related U.S. Application Data
(60) Provisional application No. 60/398,019, filed on Jul. 24, 2002.

(51) Int. Cl. H01R 13/502

(52) U.S. Cl. 439/701

(57) ABSTRACT

A apparatus having layers. A first layer has a conductive adhesive region and a non-conductive adhesive region. A second layer has an electronic component in electrical connection to the conductive adhesive regions in the first layer so that the conductive adhesive regions provide contact points for the electronic component. A third layer has an adhesive material to couple the apparatus to an object. A forth layer substantially covers the third layer.

### CROSS-REFERENCE TO RELATED APPLICATIONS

This application claims the benefit under 35 U.S.C. § 119(e) of U.S. provisional application no. 60/398,019, filed Jul. 24, 2002.

### FIELD OF THE INVENTION

The present invention relates to electronic, electro-optical and optical devices and methods for organizing, packaging and constructing such devices.

### BACKGROUND

Electronic, electro-optical, and optical devices are often combined together to form a larger system that may be used to sense and process data. For example, a central processing unit (“CPU”) may be combined with a power generation unit, a sensor and a memory to detect and record data that is generated by an outside source. The different components of such a system are often constructed by different manufacturing process, and may have varying physical properties. For example, devices may be constructed using disparate technologies such as plastic logic, silicon circuitry, thin film solar cells, thin film batteries, printed logic, wire wound resistors, etc. In many cases, solder is not feasible to directly interconnect the components because solder may destroy the components (e.g., by melting plastic logic). While certain technologies may be used to construct thin and flexible components, it is generally costly and difficult to design and manufacture a system which combines such different components into a relatively small-scale device. That is, standard manufacturing processes may not allow for the effective assembly of a variety of devices from a set of components that incorporate technologies such as listed above with a common and uniform method to both electrically and physically interconnect the devices in a single operation. By way of example only, in some instances components comprised of thin plastic films may require intermediate interconnect technologies to enable solder connections to components that can tolerate higher temperatures. Additionally these said components may require additional technologies to bind the two said disparate components together physically.

Electronic, electro-optical, and optical devices are used to sense and process data in many different types of applications. Many common objects are employed in situations were useful data is generated. Examples include objects and machines used in publishing, advertising, disposable and non-disposable medical instrumentation, aircraft, transportation and logistics, factory automation and factory floor applications, worker safety, automated workflow systems, environmental monitoring, fashion, novelty and entertainment, sports and sporting equipment, organization of physical objects, autos, trucks, buses and other transportation equipment, education, law enforcement and security, retail operations, agriculture, military, scientific, developmental, and consumer research.

In many cases, the desirability of collecting this data is often not recognized when the object is designed. In other cases, the object may also be used in a variety of applications which do not involve data to be processed, and thus building in of a data processing function at design time may not be cost effective. Thus, because of cost and other design considerations, objects often do not have the built-in capability to collect or process data.

The present invention overcomes the problems of the prior art by providing modular building blocks that may be easily combined and placed into manufacture to form a device for sensing and processing data and may be easily attached to an existing object.

### SUMMARY OF THE INVENTION

In embodiments of the present invention, modules are combined to form a system. In an embodiment, each module may comprise a plurality of layers. A first layer may have a non-conductive adhesive region and a conductive adhesive region. A second layer may have an electronic component in electrical connection to the conductive adhesive regions in the first layer so that the conductive adhesive regions provide contact points for the electronic component. In an embodiment, a third layer may have an adhesive material to couple the apparatus to an object. In a further embodiment, an adhesive layer of a first module may be coupled to an adhesive layer in a second module so that conductive adhesive regions in the first module are coupled to conductive adhesive regions in the second module to create an electrical path between the electronic component in the first module and the electronic component in the second module. A cover layer may be removed from the first module, a cover layer may be removed from the second module, and the first module and second module may be coupled together using adhesive layers.

Embodiments of the present invention provide electronic, electro-optical or optical devices that may be used in place of conventional circuitry but which provides advantages over convention circuitry. One advantage provided by embodiments of the present invention is the ease of development. Devices employing the present invention may be designed, prototyped, tested, and reconfigured in a much shorter time span and a greatly reduced cost than conventional existing technical methods and components. In addition, devices employing embodiments of the present invention may move seamlessly from the prototype stage to the manufactured final device at very low cost. When embodiments of the present invention are used, manufacturing engineering may not be required, thus providing substantial time and expense advantages during this transition from prototype to final product.

In addition, devices employing the present invention may have physical characteristics that expand the scope of available applications, reduce the engineering cost of applying the devices to other systems or products, and speed-up and reduce the cost of real world application. First, devices constructed according to embodiments of the present invention may be thin, having for example a thickness of fractions of a millimeter. Second, devices constructed according to embodiments of the present invention may be highly flexible and may conform to the shapes of other objects. Third, devices constructed according to embodiments of the present invention may have an adhesive backing with a releasable cover that enables them to be attached to objects and put into service immediately. Forth, devices constructed according to embodiments of the present invention may also weigh less than conventional electronic packaged devices.

Thus, because of new and unique properties, the present invention may dramatically decrease the time and expense of developing, constructing and applying new electronic, electro-optical, optical devices and sensors.

### BRIEF DESCRIPTION OF THE DRAWINGS

FIG. 1 is a block diagram of modules connected together to form a system and attached to an object in accordance with an embodiment of the present invention.

FIG. 2 is a block diagram of an edge view of a module in accordance with an embodiment of the present invention.

FIG. 3 is a block diagram showing further details of modules connected together to form a system in accordance with an embodiment of the present invention.

FIG. 4 is a flow diagram of a method of constructing a circuit in accordance with an embodiment of the present invention.

FIG. 5 is a block diagram of a system in a resting position and a system attached to an object in accordance with an embodiment of the present invention.

FIG. 6 is a block diagram of network of devices in accordance with an embodiment of the present invention.

FIG. 7 is a flow diagram of processing data related to an object in accordance with an embodiment of the present invention.

FIG. 8 is a block diagram that represents transfer of a system from the prototype stage to the manufactured final device in accordance with an embodiment of the present invention.

FIG. 9 is a block diagram of a development CPU unit in accordance with an embodiment of the present invention.

### DETAILED DESCRIPTION

Following is a description of several examples of attachable modular electronic systems and methods of making and using such systems. It will be appreciated that modifications and variations of these examples are covered by the teachings provided below and are within the purview of the appended claims.

According to embodiments of the present invention, basic electronic components are organized into modules which may share a set of common basic qualities and characteristics. Embodiments of the present invention may be used in place of conventional electronic and optical devices. According to embodiments of the present invention, devices are designed to be attached to objects with, by way of example only, an adhesive peel away backing. Such devices may be thin and flexible and may be placed into operation in many situations where a redesign of the object would be necessary to accommodate the incorporation of conventional electronic devices.

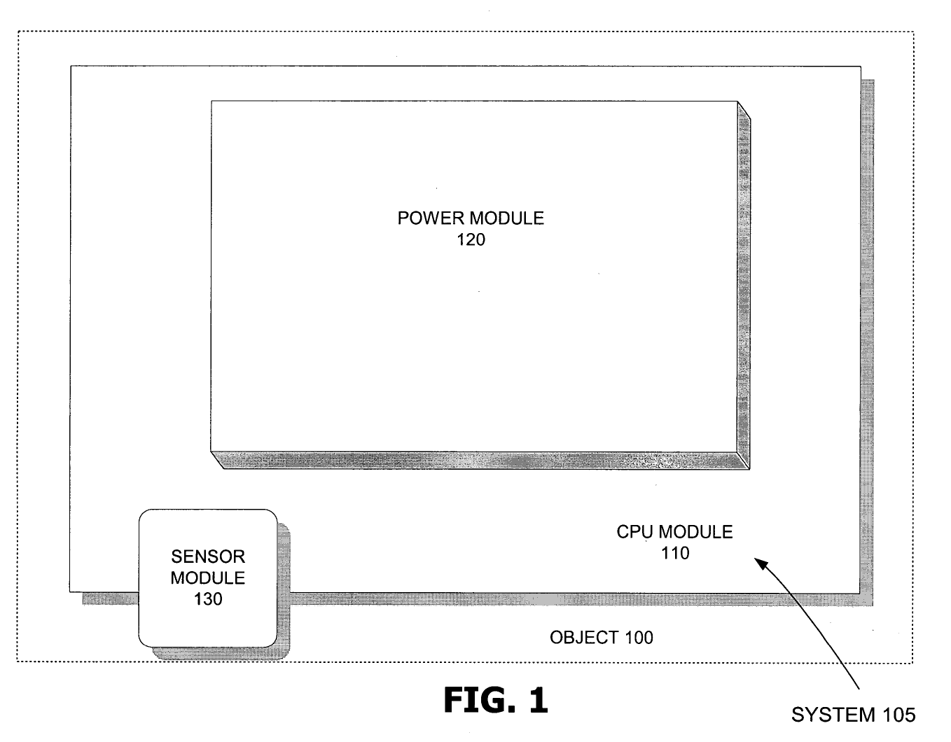

FIG. 1 is a block diagram of modules connected together to form a system and attached to an object in accordance with an embodiment of the present invention. In FIG. 1, a system 105 is attached to an object 100. Object 100 may be any type of object, such as one of the many types of objects described below, and system 105 may process data relating to that object. For example, object 100 may be a machine and system 105 may sense the temperature at the machine. In an embodiment, and as described in more detail below, an adhesive on the bottom of system 105 (not shown in FIG. 1) may adhere system 105 to object 100.

As shown in FIG. 1, system 105 comprises a CPU module 110, power module 120, and sensor module 130. In this embodiment, a bottom side of power module 120 (not shown in FIG. 1) is adhered to a top side of CPU module 110, and a portion of a bottom side of sensor module 130 (not shown in FIG. 1) is adhered to the top side of CPU module 110. In an embodiment, power module 120 and sensor module 130 each include an adhesive layer on the bottom side of the respective modules which is used to adhere the module to CPU module 110. In an embodiment, CPU module 110 includes a top-side adhesive layer that adheres to power module 120 and sensor module 130. In an embodiment, module 110 does not contain a top-side adhesive, but rather may be adhered to other modules (such as power module 120) by adhesive on the bottom-side of the other module. In a further embodiment, CPU module 110 includes an adhesive layer on the bottom side which may be used to adhere the module to object 100. In an embodiment, sensor module 130 is a temperature sensor that senses the air temperature, power module 120 provides power to CPU module 110 (and indirectly to sensor module 130), and CPU module 110 processes temperature data received from sensor module 130.

In the embodiment shown in FIG. 1, only a portion of the bottom of sensor module 130 is adhered to CPU module 110. In such an embodiment, the portion of the bottom of sensor module 130 that is not adhered to CPU module 110 may be covered by a removable cover. In some embodiments, owing to the final use of the system, the removable cover material may not be sufficient to protect the finished device. In such cases, an alternative more robust material may be used to replace the original removable cover material and may be placed over the portion of back of sensor module 130 that is not adhered to CPU module 110.

Because it is attached to the object 105, the CPU module may be referred to as the primary module. Because power module 120 and sensor module 130 are attached to the primary module, they may be referred to as secondary modules. Primary modules may connect to secondary modules, by way of example only, on the topside of the primary module or on an edge of the primary module.

The bottom side of the primary module may be covered with an appropriate adhesive material that, prior to being adhered to an object, may be covered with a removable cover. This bottom side cover may be removed to enable the devices (given the appropriate adhesive) to be attached to any object such as, by way of example only, a car window, a machine tool, a test tube, a human arm, a magazine page, a tire, a sail, etc.

Secondary modules may be connected to primary modules on their bottom-side. In some instances, and as shown in FIG. 1, secondary modules may connect to primary modules with a small overlap so that the larger portion of the secondary module may extend beyond the physical boundary of the primary module. In other instances, the entire perimeter of the secondary module may fit within the boundary of the primary module, as with power module 120 of FIG. 1. In those instances where a portion of the secondary module extends beyond the boundary of the primary module, that surface may be coated with the same adhesive as the primary module and may also have a removable backing. This may enable the finished device to be fully attached to objects.

According to embodiments of the present invention, the system is subdivided into microprocessor and memory, power source, sensor and actuator modules. In some embodiments, a single module may contain any combination of the above.

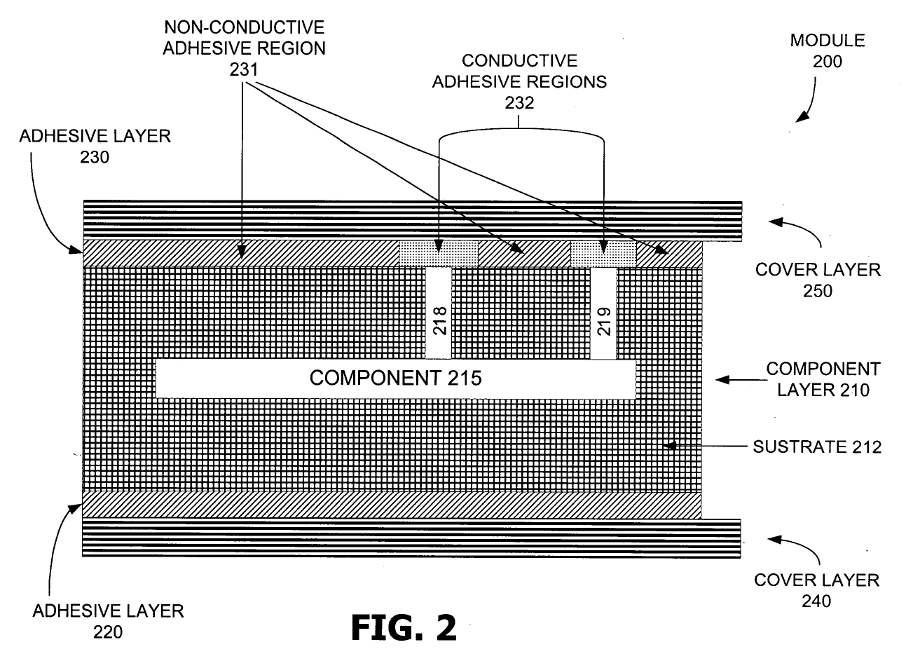

FIG. 2 is a block diagram of an edge view of a module in accordance with an embodiment of the present invention. FIG. 2 illustrates an edge side view of a typical module used in embodiments of the present invention, such as for example CPU module 110, power module 120, and/or sensor module 130 of FIG. 1. However, in other embodiments other constructions may be used.

The module 200 shown in FIG. 2 comprises a plurality of layers. At the center of module 200 is a component layer 210. An adhesive layer 230 is on top of component layer 210, and a cover layer 250 is on top of adhesive layer 230. An adhesive layer 220 is on the bottom of component layer 210, and a cover layer 240 is on the bottom of adhesive layer 220. Component layer 210 contains a substrate 212, a component 215, and conductive paths 218 and 219. Conductive paths 218 and 219 may be any type of conductive material and may be coupled to contact points on component 215.

Component 215 may be any of the full range of basic electronic and optical passive and active components. The possible component types include, but are not limited to, resistors, physical switches, including thin pressure sensitive switches of all types, inductors, capacitors, transistors, amplifiers, all categories of logic devices, operational amplifiers, microprocessors, signal processors, diodes, thermisters, thermocouples and other temperature sensors, photo transistors, buffers, frequency-voltage-current peak detectors, counters, demodulators and modulators, voltage and current regulators, active and passive frequency filters, phase locked loops, oscillators, radio detectors, mixers, radio transmitters and receivers, antennas, LEDs, solar cells, wave guides, optical wave guides, optical gratings, thin film batteries, read/write and programmable read only electronic memory, magnetic sensors and Hall effect devices, electromagnets, liquid crystal displays, electronic paths and transmission lines, and wires. In each instance, the component may be constructed to be flexible. By way of example only, memory and microprocessor components may be constructed on extremely thin forms of silicon substrate and glued with conductive and non-conductive adhesives. In other cases, the components may be made as part of the flexible substrate in the form of, by way of example only, plastic electronic or optical components. In other instances, the components may be painted, printed, sputtered or coated on the substrate 212.

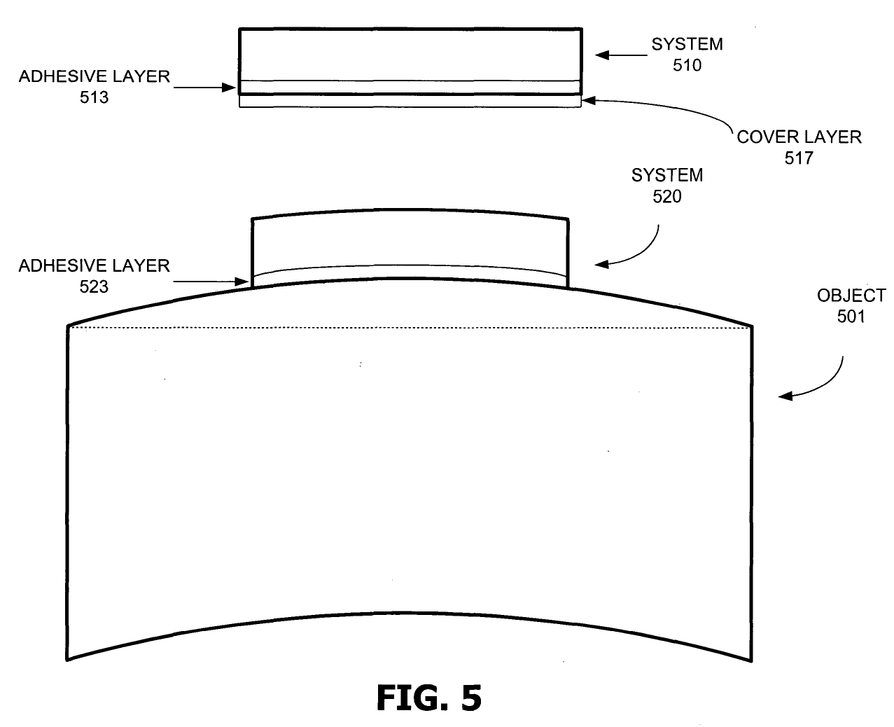

Substrate 212 may be a flexible substrate. By way of example only, substrate 212 may be plastic, plastic composites (composites being plastic with embedded fibers or particles or metals, glass, carbon, advanced plastic fibers such as Kevlar®, or organic and natural organic particles or fibers), paper, thin silicon, plastic coated metal, cloth or other natural materials. In each instance, the module may exhibit a minimum degree of flexibility to be able to be conformal to a cylinder or other object with a minimum radius of between 0.1 and 10 inches or more, with a preferred range of 0.5 to 2.0 inches, and a most preferred range of 0.2 to 1 inches. This flex radius feature is further discussed below with reference to FIG. 5.

Adhesive layer 220 and adhesive layer 230 may be a glue or other adhesive material such as, by way of example only, acrylic based adhesive, epoxy adhesives, silicone adhesives, urethane adhesives or combinations thereof. As used herein, when the adhesive material couples to an object or module, the adhesive material creates a bond at the normal environmental temperature that does not destroy the component, that may or may not be permanent, and that is adequate to support the functionality of electronic interconnects and contribute to the physical bonding of the modules. Cover layer 240 and cover layer 250 may be peal away strips which, if pealed away, may expose adhesive layers 220 and 230. An adhesive layer may contain a pattern of conductive and non-conductive adhesives. As shown in FIG. 2, adhesive layer 230 contains non-conductive adhesive regions 231 and conductive adhesive regions 232. In an embodiment, the adhesive layer 230 only contains a single conductive adhesive region.

According to embodiments of the present invention, devices may attach and interconnect to each other by alternating patterns of conductive and non-conductive adhesives such as non-conductive adhesive regions 231 and conductive adhesive regions 232. The patterns of conductive and non-conductive adhesives may be designed to facilitate a logical system of interconnection (electronic digital and analogue and optical) between various modules in the system. Prior to assembly, the adhesives may be covered by a removable cover material such as cover layer 250. As discussed above, this backing material may be peeled away and removed to permit attachment between various modules. In another embodiment, the module only contains one adhesive layer (e.g., adhesive layer 230). In an embodiment, the conductive regions do not comprise an adhesive material. In an embodiment, optical regions may be used in adhesive layer 230 to create a path from component 215 to another module.

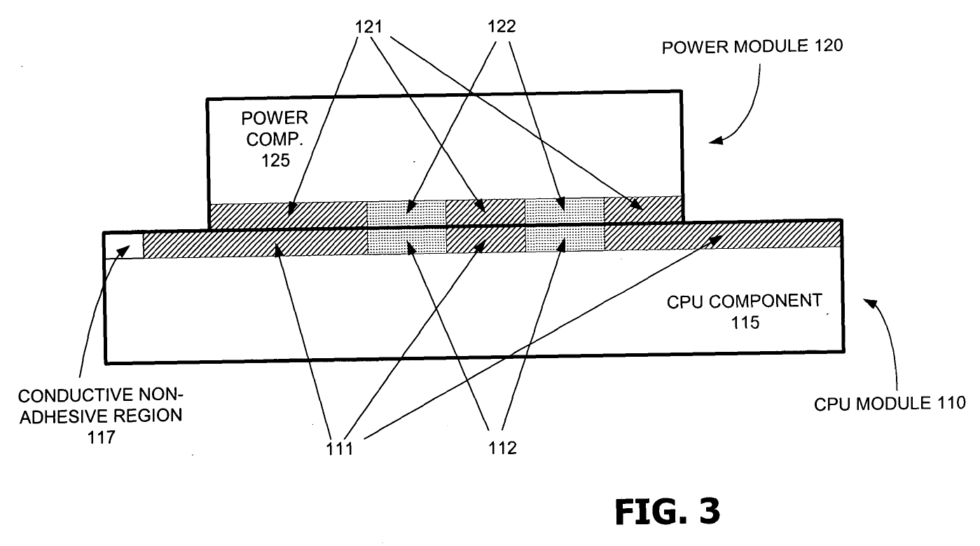

FIG. 3 is a block diagram showing further details of modules connected together to form a system in accordance with an embodiment of the present invention. In FIG. 3, CPU module 110 is adhered to power module 120 as shown in FIG. 1. In the embodiment shown in FIG. 3, CPU module 110 comprises a layer of non-conductive adhesive regions 111 and conductive adhesive regions 112 formed on a CPU component 115. Similarly, power module 120 comprises a layer of non-conductive adhesive regions 111 and conductive adhesive regions 112 formed underneath a power component 125. Thus, in this embodiment, the CPU module 110 and power module 120 each have a single adhesive layer. Unlike the module 200 of FIG. 2, in FIG. 3 the CPU module 110 and power module 120 do not contain a substrate. In other words, the CPU component 115 comprises the entire component layer of CPU module 110, and the power component 125 comprises the entire component layer of power module 120 (i.e., no substrate is used). As discussed above, in another embodiment the modules may be connected by a single conductive layer in one of the modules. As also discussed above, the conductive regions in one of the modules may be non-adhesive. For example, in an alternative embodiment, CPU module 110 does not include non-conductive adhesive regions 111, and conductive regions 112 may be non-adhesive.

As shown in FIG. 3, power module 120 is coupled to CPU module 120 by adhesive regions 111, 112, 121, and 122. In particular, conductive regions 112 in CPU module 110 is coupled to conductive regions 122 in power module 120 to form electrical paths between power component 125 and CPU component 115. The paths allow the components 110 and 120 to send and receive signals (which in this case would include a power current) to the other component. In other embodiments, the components are interconnected by optical paths (e.g., regions 122 and 112 may be optical paths).

To provide temporary interconnections, modules may have conductive non adhesive electronic contact regions or arrays, for example on the side or on top surface, which may be used to electrically connect the module to outside electronic and logic devices including Personal Computers (“PCs”). In FIG. 3, CPU module 110 has a conductive non-adhesive region 117 which may be used to program a read only memory in CPU module 110 (not shown) or to perform certain circuit test and quality assurance tests.

According to embodiments of the present invention, a query based software system is used. Such software may be run on ordinary PCs or network servers and may be used to program the modular devices. This language may operate by presenting a series of organized questions to the user. These questions may be hyper linked by logical methods to extract from the user the use of the device, the modules that may be used, and the sequence and timing of events and procedures. Following a query session a user may be presented with a visual diagram that symbolizes the order and programming of the device. Upon approval by the user, the language may be used to program finished devices through direct connection between the device and a PC, for example via a conductive non-adhesive region, or by transferring the program to an automated assembly machine as discussed below.

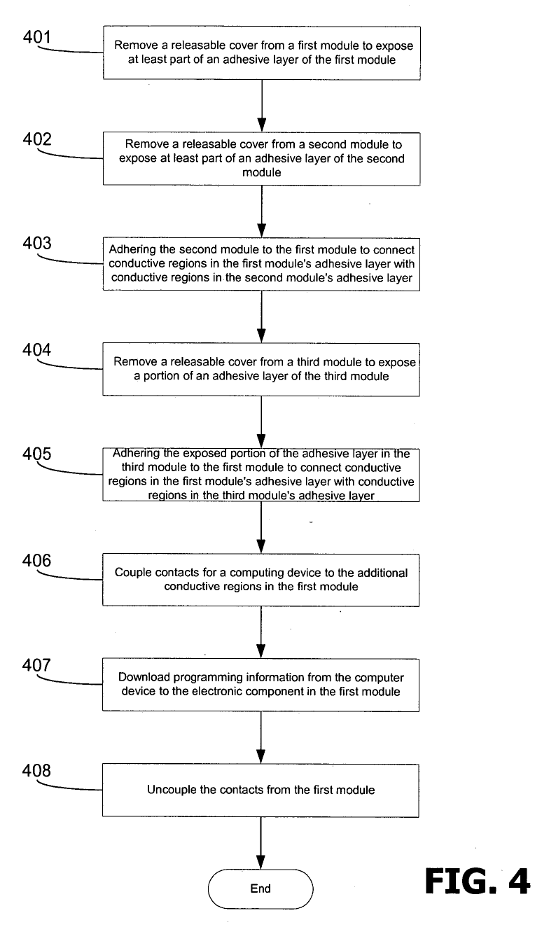

FIG. 4 is a flow diagram of a method of constructing a circuit in accordance with an embodiment of the present invention. This method may be used, for example, to construct the system 105 shown in FIG. 3. A releasable cover may be removed from a first module, such as CPU module 110, to expose at least part of an adhesive layer of the first module (401). A releasable cover may be removed from a second module, such as power module 120, to expose at least part of an adhesive layer of the first module (402). The second module may be adhered to the first module to connect conductive regions in the first module's adhesive layer with conductive regions in the second module's adhesive layer (403). For example, and as shown in FIG. 3, conductive regions 122 in power module 120 may be adhered to conductive regions 112 in CPU module 110. In embodiments, non-conductive regions (such as 121) in the second module may also be adhered to non-conductive regions (such as 111) in the first module.

In a further embodiment, a releasable cover may be removed from a third module, such as sensor module 130 of FIG. 1, to expose a portion of an adhesive layer of the third module (404). The exposed portion of the adhesive layer of the third module may be adhered to the first module to connect conductive regions in the first module's adhesive layer with conductive regions in the third module's adhesive layer (405). As shown in FIG. 1, for example, a portion of an adhesive layer on the bottom of sensor module 130 may be adhered to CPU module 110. In a further embodiment, the portion of sensor module 130 that is not adhered to CPU module 110 may instead be adhered directly to object 100.

In a further embodiment, contacts for a computing device are coupled to additional conductive regions in the first module (e.g., 117 in FIG. 3) (406) programming information is downloaded from the computer device to the electronic component in the first module (407), and the contacts are uncoupled from the first module (408). In some embodiments, mechanical attachment may occur between adhesive surfaces, or between a single adhesive surface and a non-adhesive surface. This may include both conductive and non-conductive mechanical attachments.

FIG. 5 is a block diagram of a system in a resting state and a system attached to an object in accordance with an embodiment of the present invention. FIG. 5 illustrates that according to embodiments of the present invention, a system may flex to conform to the shape of an object. FIG. 5 shows an object 501 and two systems, 510 and 520. Object 501 may be any type of object, such as one of the many types of objects described herein. System 510 and system 520 may be any of the systems described herein, such as system 105 of FIG. 1. System 510 and system 520 may be the same type of system. System 510 has an adhesive layer 513 and system 520 has an adhesive layer 523. System 510 also has a cover layer 517 that covers adhesive layer 513. As shown in FIG. 5, system 520 does not have a cover layer.

When not adhered to an object (i.e., when in a natural resting position), a system according to the present invention may be flat, as shown by system 510. To adhere the system to an object, a cover layer may be removed to expose an adhesive layer (such as adhesive layer 513). The adhesive layer may then be adhered to a surface of the object, as shown by adhesive layer 523 adhering to object 501. If the surface of the object is curved, the system may flex to conform to the shape of that surface. For example, system 520 may flex to conform to the surface of object 501. In an embodiment, system 520 has a flex radius of 0.1 inches.

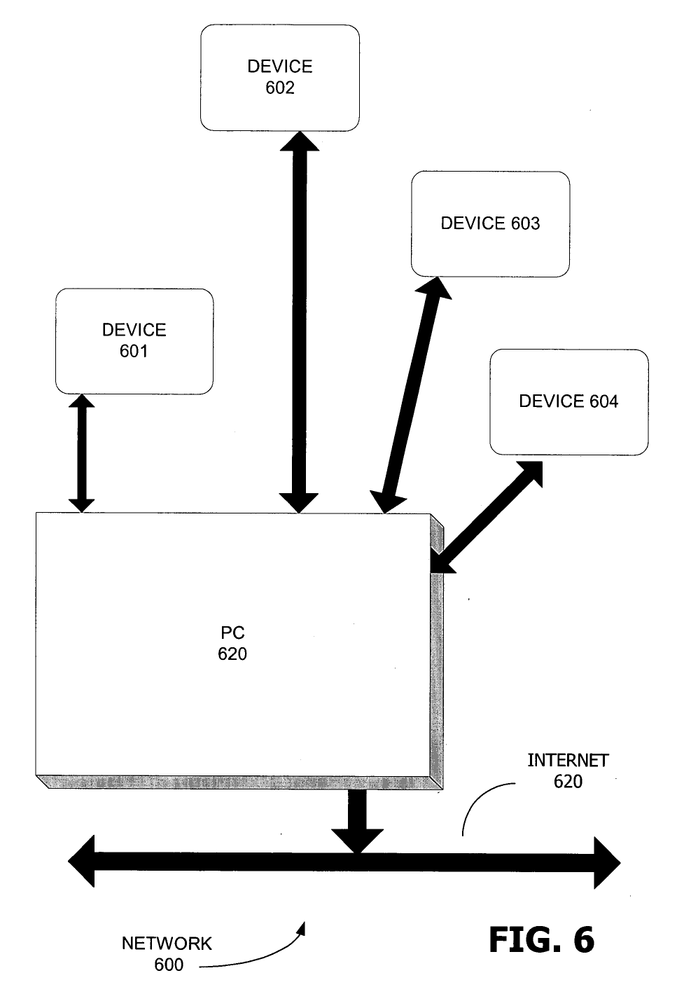

FIG. 6 is a block diagram of network of devices in accordance with an embodiment of the present invention. The network in FIG. 6 may be a self-organizing network. FIG. 6 shows a network 600 that includes a PC 602 and devices 601 to 604. Devices 601 to 604 may be modules which embody the present invention as described above. Devices 601 to 604 may be any of the communication devices described below. As shown in FIG. 6, the network is coupled to an Internet 620. The devices in FIG. 6 may be connected to PC 620 by wires or radio waves.

In embodiment of the present invention, the system contains devices critical for communicating and interfacing with both humans, animals and mechanical and electrical machines including computers. Such communication devices may include but are not limited to the following: microphones or other full spectrum audio wave detector devices, audio output devices, digital serial or parallel output and input gate devices, LCDs, LEDs, and other optical input output devices, Hall effect sensors, magnetic coils, high frequency radio transmitters and receivers, and radio antennas. An important communication function may be built into modules which may be capable of functioning as a self-organizing local network (such as shown in FIG. 6) that may be interconnected either by wires, audio signals, infrared waves, or radio waves. This facility may be enabled by the incorporation of wire audio transceivers, infrared transceivers, or radio transceivers into modules. The modules may be controlled by microprocessors and the associated support circuitry including memory components. Such self-organizing networks may report to personal computers or network servers via a radio or wire network interface device attached to personal computers or servers. A PC or server in turn may be connected to the Internet by conventional means and thus connect a set of modules to the Internet. Interfacing and interconnecting such devices may also be accomplished through the use of bridges as described below. Any of these devices may be contained in either primary or secondary modules.

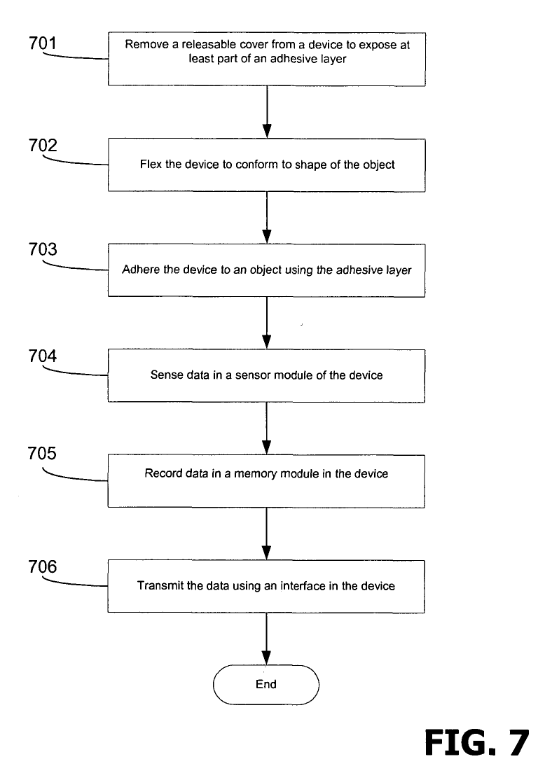

FIG. 7 is a flow diagram of processing data related to an object in accordance with an embodiment of the present invention. According to an embodiment of the invention, a releasable cover may be removed from a device to expose at least part of an adhesive layer (701). For example, with reference to the embodiment shown in FIG. 5, the cover layer 517 may be removed from system 510. The device may be flexed to conform to shape of the object (702). For example, the system may be flexed to conform to the shape of the surface of object 501. The device may be adhered to the object using the adhesive layer (703), as shown by adhesive layer 523 adhering to object 501. Data may then be sensed in a module of the device (704), such as by sensor module 130 of FIG. 1. The data may then be recorded in a memory module in the device (705). Data may be transmitted using an interface in the device (706), for example as shown in FIG. 6.

System Assembly and Manufacture

The present invention includes two categories of modules: Developmental Modules and Production Modules; hereafter referred to as DMs and PMs, respectively. DMs are generally larger than PMs and may be aligned, attached and assembled into finished electronic, electro-optical and optical devices by hand. PMs may be generally smaller and are assembled into finished electronic, electro-optical and optical devices by dedicated production machines, or manufacturing lines, which perform the necessary alignment of the individual modules automatically. Each respective DMs and PMs which perform the same function may exhibit identical electrical and optical characteristics, so that if a device is created with a set of DMs it may be duplicated on a smaller physical scale with machine assembled PMs.

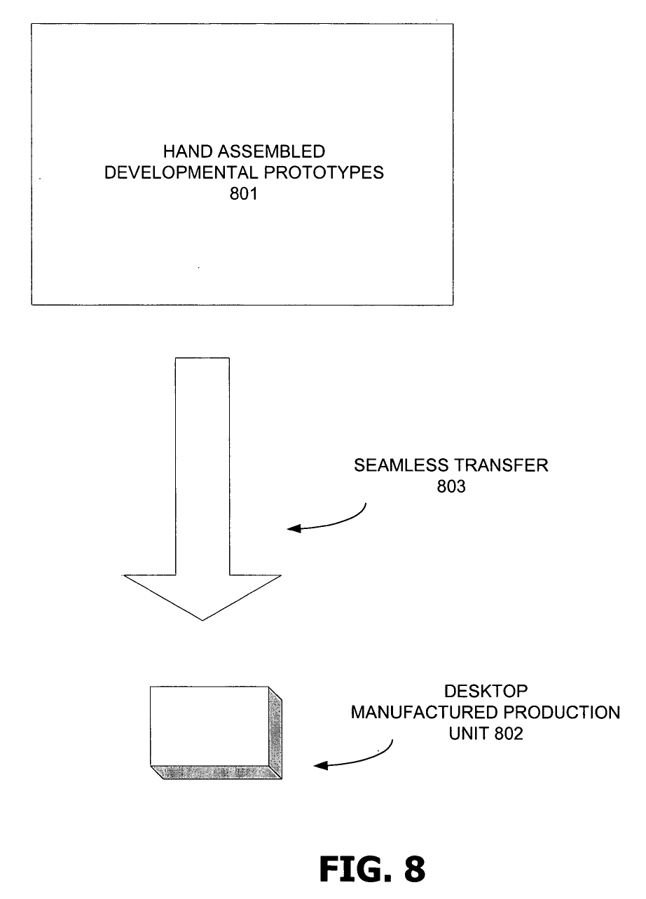

FIG. 8 is a block diagram that represents transfer of a system from the prototype stage to the manufactured final device in accordance with an embodiment of the present invention. A hand assembled developmental prototype 801 may be constructed as disclosed herein. As further disclosed herein, and according to embodiments of the present invention, a seamless transfer 803 may then be made to a desktop manufactured production unit 802.

DMs may have small holes, less than ⅛^{th} of an inch in diameters, spaced, by way of example only, in symmetrical rectangular arrays, which match alignment pins protruding on the DM assembly base tool. In addition, DMs may have a peel away backing perforated in patterns to match conductive arrays on other DMs. On DMs, these peel away backings may overlap and extend beyond the surface of both the top and bottom of the DMs so they may be gripped by hand and removed. PMs may be provided in long strips of backing material so they may be coiled onto reels and be directed into automated assembly machines. The bottom backing material on PMs may also have small overlapping sections so they may be removed and attached to objects as finished devices.

According to an embodiment, a special clamp device may be provided for use with DMs to provide the appropriate pressure to electrically connect the DM to outside electrical devices and in particular to connect either in serial or parallel to an external device such as, by way of example only, a personal computers. These clamp devices may incorporate interface cables and connectors to enable users to connect devices embodying the present invention to personal computers to both program and test DMs. The clamps may have a similar array of conductive and non-conductive points, which may match those on a device embodying the present invention. In use, the opened clamps may be inserted over the edge of the device. Once in position correctly over the contact arrays, the clamp may be released to make electrical contact to the contact array on the top surface of the device. After use, the clamp may be opened and removed.

PMs may have similar non-adhesive contact arrays. Automatic assembly machines may have, integrated into their internal procedures, automated contact points in the form of electrically actuated conductive pins, which may make the appropriate contact to provide electrical conductivity with the PMs contact arrays for testing and programming.

As noted above, DMs and PMs may be distinguished by their size and method of assembly. DMs are generally assembled by hand using a special set of DM tools. DMs are programmed and tested by attaching special clamps and cables to interface with computers and other programming or electronic test equipment. PMs may be assembled and tested using a specialized automated assembly and testing machine. The PM assembly machine may be small enough to be designated as a “desktop manufacturing device”. In some instances, in order to produce robust devices, PMs may be attached with special “hard adhesives”, such as by way of example ultraviolet cured epoxies, to insure that such devices may operate in harsh environments.

DMs may be assembled by hand using a DM assembly base tool that is, by way of example only, a rectangular base coated or made of Teflon®, which may incorporate a symmetrical array of steel Teflon® coated pins that protrude vertically from the base tool. Such pins may align the secondary modules to various exact positions on the primary modules so that the arrays of conductive and non-conductive pads may correctly align to the appropriate positions functionally. The number of pins may vary from 4 to 16 or more per square inch and have a small diameter (say less than 3/32 of an inch) so that the modules may easily slide up and down the pin arrays. The pins may be rounded on top to ease placement of the modules.

By way of example only, one DM assembly procedure is as follows. The primary DM is prepared by removing the appropriate sections of the backing material that covers various sections of the primary DM exposing the arrays of adhesives. The primary DM is then placed over the base tool and lowered, with the adhesive side up to the base through the pin array. Next, the secondary modules to be attached to the primary module are in sequence prepared by removing the appropriate section of the backing material exposing the appropriate adhesive arrays. The secondary modules are then lowered to attach to the primary module, with the adhesive side facing down, appropriately aligned and guided by the pins to attach to the primary module. After all modules are in place, the now-completed device is lifted from the base tool and pressed firmly by a hand operated Teflon® coated roller to insure good adhesion. The device constructed from DMs may be programmed and tested and put into use.

PMs are assembled in the same manner except that an automated manufacturing device may carry out all module preparation and alignment and adhesion functions. The automated PM assembly machine may be a fully programmable device based upon an internal computer or an interface to a standard PC. This machine may accommodate the full range of PMs. PMs may be packaged in reels, similar to the packaging of conventional surface mounted electronic components. Each component may be backed on both sides by a removable backing. The machine may separate the cover of the adhesive arrays from the PMs in the appropriate sections by various automated film feed and pull devices. These devices may be, by way of example only, vacuum based, simple film rollers or servo-actuated clamps. The reels of various PMs may feed into stepped ports located in a semi circle located on one side of the machine. The removed and waste covers may exit the machine to a disposal container located under the machine. Inside the machine may be a rotating drum or cylinder of moderate height, slightly larger than the largest PM. The drum may be perforated with small holes between 1/32 and ⅛ of an inch that are used to hold the modules to the drum via a vacuum. The drum may move in programmed steps, starting and stopping to accommodate the production sequence. Stepping motors may be used to control the movement of the cylinder.

An example of the production sequence is as follows. The primary PM is removed from its film reel strip and placed on the drum in and exact position by servo actuators. In this example, the primary module does not have its bottom side (the side facing the drum surface) adhesive backing cover removed while it is held in place via a high vacuum pulling through the holes in the drum. However, the entire top side adhesive backing of the PM has been removed. Then, the drum rotates one step to align the primary PM to the next station where a secondary PM may be attached. A secondary PM has the appropriate section of its bottom side backing cover removed and is then aligned and attached to the primary PM by servo actuators. This procedure may continue until all the PMs are attached into the completed device. Toward the end of the drum production sequence, servo actuated conductive pins contact the device via the conductive contact arrays to program and test the finished device. The devices may be removed from the drum by a vacuum retard system positioned at the final station of the drum sequence. As the vacuum is reduced, the device may fall from the drum into a collecting bin.

An alternative construction of the automated assembly machine would eliminate the rotating drum and the vacuum system and instead use the bottom film adhesive backing as the carrier during the assembly of devices. The strip containing the primary PMs may be stepped through a straight production line on a Teflon® or similar non-stick base. Rollers actuated by stepping motors may grip the strip of primary PMs at entry to the line and between secondary PM insertion stations. The line may move in stepped sequences controlled by the actuation of the stepping motors that in turn are controlled by the assembly machines computer. Secondary PMs may be attached in the same manner as in the rotating drum approach. At the end of this production line, an automated cutting device may cut and separate the individual finished devices. While specific methods of mass productions have been described herein, other methods of automation are possible and are considered within the scope of the present invention.

Interconnect Standards

To insure interoperability between modules, the present invention may provide for a set of physical, electrical and optical interface standards between primary and secondary modules. In an embodiment, all modules conform to these standards. The standards may provide that primary and secondary modules may be attached and function without interface engineering, other than programming. For example, a secondary temperature sensing module and a secondary strain gauge sensor may be connected to a primary module's analogue to digital converter without any physical adjustments or modification to match impedance, voltage levels or sensing rate frequency.

Primary and secondary modules may be electrically interconnected by a set of standard arrays' of separate adhesive conductive regions or pads. Normally, these pads are round in shape, although other shapes are possible. These arrays may be, by way of example only, in one or more lines, staggered lines, or other geometric orders. In each instance, the geometric pattern of the arrays may represent a particular standard. By way of example only, power connections may be in the pattern of an equal sided triangle set of three of conductive pads. Their orientation may insure the proper alignment of ground and positive conductors. By way of example only, inputs from secondary sensor modules to inputs to a primary module analogue to digital converter may be another three-pad array, shaped in an L pattern. Since many possible arrangements of contacts and patterns may be contemplated, it is not necessary to describe the exact patterns and geometric shapes associated with common module functions, except to indicate that these physical geometric arrangements of the adhesive conductive arrays are a critical part of the interconnect standards.

Modules may also have a set of electrical interconnect and interface standards that may describe the voltage, frequency, impedance and electrical current ranges that are assigned to particular functions. For example, power sources, normally a secondary module, may provide electrical power within a specific range of voltage and current. Inputs to analogue to digital converters may fall within a specific voltage and input impedance range. Again, it is not necessary to describe all of the electrical input and output standards, except to indicate that each basic functional input/output sector of modules may have an associated set of electrical standards. The same may hold true of electrical outputs from primary modules to secondary modules. In a similar manner, input/outputs in the optical spectrum may have common attributes. Optical wave-guide properties between various modules may be within a set of physical boundary conditions.

Bridges

In order to enable the permanent connection of devices that embody the present invention to other devices that do not conform to the present invention, a set of “bridges,” both electrical and optical, may be provided. Electrical bridges may attach to assigned bridge adhesive conductive pads located on the modules. The bridge itself may have a matched set of conductive adhesive pads to connect to the module's pads. The bridges may physically exit the module horizontally or vertically. By way of example only, a two wire electrical contact may exit a module as flat wires contacts. For example, two thin copper strips, or other conductive strips, embedded into a thin plastic film, may exit the module both horizontally and parallel with the module. A vertical electrical bridge may have two ordinary insulated wires exiting the module vertically perpendicular to the module.

Optical bridges may require additional devices to exit the module. Normally, the optical exit channel may be a fiber optic strand or another form of wave-guide. Therefore, the optical channel may connect to an optical input or output device such as, by way of example only, a phototransistor, LED, solid-state laser, cadmium sulfide cell, or other devices that transfer light input and output to electrical input or output. Such an optical bridge may have the optical channel at its center and be surrounded by a circle or oval of non conductive adhesive which may connect to a matched circle or oval of adhesive surrounding the light active portion of the module's electro-optical device. While circles are a likely choice for the geometry of the optical bridge, other shapes are possible and considered within the scope of the present invention.

An additional bridge may be provided in the form of a film strip of conductors with conductive and non conductive arrays on each end so that modules may be electrically connected and separated by the length of the film strip.

Devices Commonly Included in Modules

Certain electronic devices may perform critical functions that enable modules to be assembled into useful electronic devices. These include, but are not limited to the following: power sources, microprocessors, read/write memory, programmable read only memory, operational amplifiers, frequency and voltage filters, digital and analogue timers, phase locked loop devices, mixers, amplifiers, detectors, frequency counters, analogue to digital converters, digital to analogue converters, power management controllers including voltage and current regulators. Primary or secondary modules may contain any arrangement of these functional devices.

Other devices may be necessary to enable devices to sense chemical, physical, or dimensional conditions. These include but are not limited to: magnetic, humidity, mechanical, flow, resonant, ultrasonic, other acoustic, optical (intensity and spectrum and occurrence), chemical (organic and inorganic), rotational, acceleration, temperature, pressure, dimensional shift and biosensors. The later category of sensors, biosensors, represents a broad range of new devices either electrical or optical or combination electro-optical that are particularly useful in medical and health related applications. Any of these devices may be contained in either primary or secondary modules.

Additional devices include electrically controlled actuator devices that may enable devices embodying the present invention to modify or move other physical devices. These include, but are not limited to, micro machines, magno-restrictive metals and plastics, electro-motive plastics and compounds such as piezoelectric components and crystals. Any of these devices may be contained in either primary or secondary modules.

Power Management

Devices embodying the present invention may require electronic power to operate. In certain instances, the power may come from conventional sources: by way of example only, external power supplies, batteries, external solar cell arrays, generators and alternators. In these instances, the power may be delivered to the device by wires through bridges or inductively coupled arrangements. In certain embodiments, the power source may be built into the device and may include by any of number of power sources, by way of example only, batteries, solar cell arrays, fuel cells, etc.

In many useful applications and instances, devices embodying the present invention may not be able to draw current from external devices, and therefore in order to enable the devices to operate in those instances electronic power devices, sources and power management and regulation components must be incorporated into modules. In embodiments where the modules contains its own power source, the devices preferably should incorporate the type of electronic and optical components that may function using a minimum of energy. For example, electronic logic devices used in modules, such as microprocessors and memory, may be made using primarily static gates and registers so that refresh cycles are not required and the system clock may be slowed using analogue timers for extended periods between activities to conserve power usage.

As an alternative or in addition to internal and or external power sources, power for devices may be extracted from the operating environment using a variety of technologies and methods. Such methods and technologies include, but are not limited to, the following: solar cells, magnetic pick up coils located near moving permanent magnets (magnets attached to objects which move rotationally or in other periodic motion relative to the fixed position of the device; or the reverse where the magnet is stationary and the device is attached to a moving object), induction coils located near sources of alternating electronic current, piezoelectric components, or other devices which directly convert physical motion of objects or sectors of objects into electrical current, sources of physical resonance which drive piezoelectric components (thin reeds which resonate in gas or air flow or vibrate in response to noise present in the environment), and components which extract electrical power from temperature differentials or periodic temperature changes. Modules may incorporate robust power management circuitry managed by logic components or microprocessors, voltage regulators, current regulators and current limiters.

Modules which incorporate sensors may use those components which use the least power to perform the required sensing and detecting task. Sensor interconnect standards may provide that sensor systems may transfer information into high impedance buffers or gates.

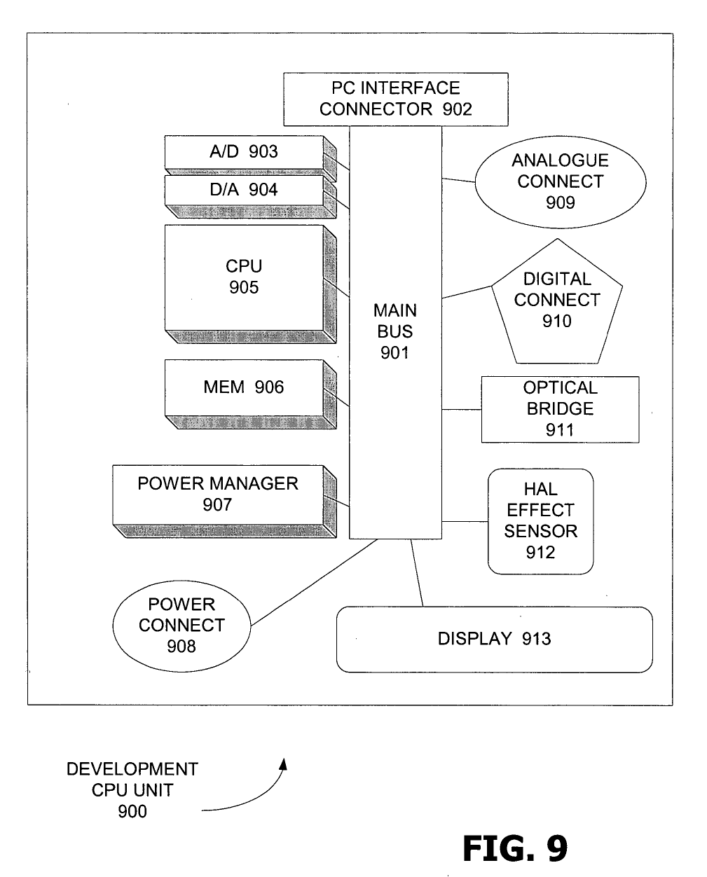

FIG. 9 is a block diagram of a development CPU unit in accordance with an embodiment of the present invention. FIG. 9 shows a development CPU unit 900 that has a main bus 901 which is coupled to a PC interface connector 902. The following may also be coupled to the main bus: an analogue to digital converter 903, a digital to analogue converter 904, a CPU 905, a memory 906, a power manager 907, a power connect 908, an analogue connect 909, a digital connect 910, and optical bridge 911, a HAL effect sensor 912, and a display 913. These components may operate as described above. Development CPU unit 900 may be used for experimentation and development of systems. As shown in FIG. 9, development CPU unit 900 includes components that may or may not be present in a production system.

### Examples of Applications

The following are examples of categories that illustrate the broad range and capabilities of the present invention to enable useful, inexpensive, and easy to create applications. Of course, additional applications not discussed herein are also considered within the scope of the present invention.

Embodiments of the present invention may be used in the instance of upgrading an existing medical instrumentation devices. For example, a device embodying the present invention may be created that may increase the resolution of an older model EKG machines by improving the quality of the operational amplifier circuitry and the control over the operational amplifier circuitry. This may also be engineered with conventional circuitry. Such a device may be prototyped, tested and manufactured in a fraction of the time and cost required to develop conventional circuitry. More importantly, the device may be inserted into the existing medical device by easily attaching it to a physical object inside the existing EKG monitor by adhering it to a filter capacitor, or an open space on the circuit board, or to the inside wall of the monitor's housing. The device may be connected to the existing circuit via a bridge and may acquire its power from the existing power bus of the monitor. Upgrading, modifying, or repairing existing devices is thus greatly simplified and made less expensive.

Another medical example is creating a smart test tube label for on site testing of blood samples or other organic or inorganic liquids. For example, circuitry may be created using the present invention that may duplicate the circuitry of existing blood sugar testing systems. A bridge in combination with an attached sensor may be directed to the inside of the test tube; this “label” may be adhered to the outside of the test tube. If, at the time the blood is drawn, the blood sample were to register a dangerously high blood sugar level, an LCD indicator on the outside-attached label may indicate to the nurse drawing the blood of this dangerous condition. Remedial action may commence at once without having to wait for laboratory processing. It is important to note that in this application, it is not necessary to re-engineer the test tube or to modify the current pattern of use methods. All that is required is to stick the “label” to the test tube.

Another example is to create a device according to the present invention that may sense ultra high frequency audio waves that are known to indicate the impending stress failure of metal parts. Such devices may incorporate sense and store devices, radio transceivers and solar power sources. In one case, such devices may be attached to the metal trusses of bridges which span rivers. In use, a bridge inspection technician may strobe (e.g., collect the stored information of the audio spectrum output of the bridge trusses) the devices by simply driving over the bridge. Inside his car, a corresponding device may by radio wave transmission and reception record the output of the bridge sensors for input and analysis by a portable PC. This may greatly reduce the cost and expense of insuring that our bridges are safe. This application is made economical because of the ease of sticking the sensors to the bridge trusses.

Similar stress indicators may be applied to metal beams that are used in buildings or to stress sections of airplane structures in order to monitor their condition and predict failure conditions. The flexible, thin structure and self-adhesion character of such devices make these applications more economic and therefore possible to carry out and apply on a broad scale. In the case of airplane structures, such devices may be adhered to sections that are difficult to reach and ones that have curved surfaces without specially engineering required to conform conventional sensor modules. In these instances, power and communication may be directed to the devices via twisted wired cables that interconnect to the devices via bridges.

As another example, audio spectrum devices constructed according to the present invention, with embedded analysis, store, and send capabilities, may be applied to various rotating machines in order to detect impending bearing failure. Current solutions for this problem are expensive and often require special engineering to attach the devices to the machines. The present invention may be used to reduce the cost and ease the application of such technology. In many cases, the best signal to noise ratio of rotating machines is available on rotating shafts or moving sections. Conventional technologies cannot accomplish this without substantial modification of the existing machine. A device constructed according to the present invention may easily be attached to moving parts, and in addition it may draw power needs from coils positioned next to stationary magnets. Such a device may communicate its sensed information with HAL effect devices, infrared transceivers, or RF devices. The reduced cost and ease of application may enable audio spectrum devices employing the present invention to be applied to a range of rotating machinery and devices that cannot be accessed given the cost and engineering challenges presented by conventional technology. This may extend to including rotating machinery used in the home environment, such as lawn mowers, and power shop tools.

Among the advantages of-devices constructed according to the present invention are that the may be very lightweight. An example of how this may be effectively used is illustrated in the application to the growing hobby of radio control airplanes, which may be small and light enough to be flown indoors. Removing weight from these models has constrained the industry's growth. Conventional technologies use separate radio receivers, batteries and servo devices interconnected by wires. A single integrated unit may be constructed using modules according to embodiments of the present invention which may contain a radio receiver, battery, and plastic electro motive strips which may be used to warp control surfaces in order to control an extremely light-weight flying indoor model. Current technologies applied to these models are expensive, and the present invention may be used to reduce the cost.

Another example of an application of the present invention is practical smart postage stamps and shipping labels for envelopes. Such stamps may be constructed of modules including a microprocessor, memory, battery and Hall effect transceiver. The customer using a Hall effect interface from a PC to the stamp or label would program the stamp. The programmed information would contain the sender's address, the destination, the type of postage, preferred routing, insurance amount, handling preferences and other information. Hall effect transceivers in use by the carrier may access this information to self direct the letter or package, designate handling and other preferences, track its progress through the shipping and delivery sequence, and automatically bill the customer. Devices such as temperature sensors, humidity sensors, and accelerometers may be used to determine the temperature, humidity and acceleration that a package has experienced in order to evaluate claims for damages.

In other instances, devices embodying the present invention may be attached to tickets for sporting, music or theater events. These smart tickets may be constructed so they may admit and direct the customer to their seats automatically using localized RF devices stationed throughout the stadium or performance center. They also may be programmed to offer last minute options to the customer in those cases where event seating is not sold out and better seats are available. In this case, new seats may be assigned and the customer would be automatically billed. Such a smart ticket device may contain an RF transceiver, battery, LCD display, and processor and memory. The smart tickets may also offer the customer discounts on product sold at concession venders, and discounts or opportunities to purchase tickets for future events.

In another useful medical embodiment, “labels” constructed according to the present invention may be attached to pharmaceuticals in both the hospital and home settings. Such a smart medicine label may track the use of medicines in the hospital, confirming that the correct medicines have be delivered to the patient and administered, and also to provide warnings of mistaken delivery. This may be accomplished by labels that would communicate via RF devices with patient record labels attached to the patient's bedside. In the home, such smart labels may remind the user of the dosage, and enable automatic refill ordering through audio transceivers designed to be used in conjunction with normal telephones. Such technology is in use today to report heart monitor results to processing centers.

The combination of devices embodying the present invention may enable applications that are not currently possible with existing technology. Wind direction indicators may be created which may be attached to multiple sections of racing sails on sailboats. Such devices may contain differential thermisters arrays that may sense changes in wind speed and direction over both the front and backside of sail surfaces, and report these changes via localized (low power) RF transmitters. Power may be provided by solar cells and linked batteries. This may provide the sailor with exacting information to assist in trimming sails to maximize performance. The combination of characteristics of thin construction, flexibility, lightweight and adhesive backing and the capability to operate independently without connective wires would make this application feasible.

In the office automation context, embodiments of the present invention may be used to create smart tags and labels that may be attached to file drawers, files in the file drawers and documents. These tags may be used to track essential document flow and to coordinate the paper document's use and flow with a company's information system. The labels may be scanned using infrared transceivers in both the label and wands attached to PCs and PDAs. Devices embodying the present invention may be used by field agents and sales forces to augment paper forms and to collect, hold and transfer information independent of the local PC. In this instance the device may act as another form of back up and security protection for critical form and information retention and storage. Devices may be attached to office information equipment, printers, PCs, PDAs, servers, and network hubs. In this instance, the device would provide an independent source of inventory recording and control. The device may also provide an independent record of the purchase information, service records, configuration and other information that would assist machine and system problem resolution and repair.

In the publishing context, embodiments of the present invention may provide low profile, lightweight, and flexibility that may enable whole new capabilities for the publishing industry, including smart devices as part of the publication. On example is an independent, stand-alone use, such as where the output of a device would be read by the reader from LCD displays that are constructed according to an embodiment of the present invention. As another example, the present invention may enable, infrared or HAL effect, RF or other transceivers to be coupled to reader PCs in the case where the reader had a compatible transceiver interface added to their PC. In such cases, the publisher would be enabled to include smart devices in the publication, be it a book, magazine, or flyer. The uses may be to sense a condition, temperature, soil acidity, water pollution, or as a dedicated calculating device to illustrate a certain investment stratagem. User inputs may be pressure sensitive switches or keyboards that are part of the smart device, or from various sensors. Outputs may be in the form of LCD displays, or the aforementioned interface to PCs.

In the advertising context, similar technical approaches as discussed above with reference to the publishing industry may be used to produce smart advertisements that may be included in publications, or as advertising mail pieces. The uses may vary from smart dedicated calculating devices that would demonstrate the outcomes of home mortgage refinancing, life insurance and annuity products to sensor based products which may read blood sugar levels, skin dryness, moisture content of wood or cement, and record levels of sunlight over a given period for a particular location. In each case, the smart advertisement would demonstrate the problem that a particular product may solve and encourage intelligent purchase decisions by the prospective customer.

Another context where embodiments of the present invention may be used is disposable and non-disposable medical instrumentation. Devices constructed according to an embodiment of the present invention may be used to create a new category of disposable and non-disposable reusable medical instruments, which may improve and in some instances transform medical care. Such devices may be attached to a patient or existing medical instruments via an appropriate adhesive. The device may be used to sense, record, and report (via local RF transmission to networks, via HAL effect or infrared devices to nurse or doctor strobes, or by LCD displays) temperature, breathing conditions, skin moisture, blood pressure, blood oxygen levels, blood sugar levels, wetness of diapers, pulse rate, and other conditions. By attaching the device to patient care instruments, such as fluid drips and oxygen systems, the device may be used to signal nurse and doctors of failure or impending failure. In the home health care environment, all of these devices may be linked to a healthcare provider by dedicated modem machines linked by RF or other means to the device patient borne instrumentation.

Embodiments of the present invention may also be used in the aircraft industry. Devices constructed according to the present invention may be used to provide inexpensive add on instrumentation for new applications and to augment existing aircraft instrumentation. On example of such use is the stress gauges discussed above. Additional examples are emergency instruments to back up basic instrumentation such as speed, rate of climb (accomplished by arrays of thermisters), axis deflection rate (accomplished by micro machined accelerometers included in the device) and new instrumentation such as differential air flow indicators attached along a flight surface to compare air flow direction along the wing and control surfaces that would predict stall conditions.

In the transportation and logistics contexts, devices constructed according to an embodiment of the present invention may be attached to air travel tickets, luggage, and airborne freight to coordinate, control and make more secure aircraft boarding, seating, loading and unloading, and luggage retrieval. Such devices may be attached to all sorts of shipping containers to coordinate, track, and make more secure shipping schedules. In other instances, sensors may be attached to these shipping labels which may detect emissions from dangerous compounds and provide warnings either remotely via RF transmitters or via local LCD, infrared, or HAL effect devices. The labels may also record freight handling conditions. For example, the device/label may record, through the use of accelerometers, temperature and moisture sensors, the handling stress experienced by a particular shipped item. This would aid shipper and customers to resolve claims for damage of shipped items.

Devices constructed according to embodiments of the present invention may be attached on parts and subassemblies located throughout the supply chain. Such smart labels may be programmed to retain and communicate information on their stage of production, their target destination, time and location, the requirements for completion, and all of the steps from the origin of the item to their inclusion in the finished product. This information may be used in conjunction with current modes of supply chain logistics software products to coordinate, control and perfect the movement of parts and subassemblies through complex operations into a final product.

In the context of factory automation and factory floor applications, devices constructed according to the present invention may be used, as in the examples cited above, to construct add-on instrumentation for machine tools, hand held tools, and other factory equipment such as conveyor systems, lifts, cranes, forging and stamping machines. Such devices may sense, store, analyze, and report. The reporting technology may vary from visual indicators to the operator of the tool or system, or transfer information through the variety of communication channels discussed herein to existing instrumentation or micro controllers or computers. The sensing functions may include temperature, rotation occurrence or oscillation rates, vibration, the presence of organic or inorganic compounds, liquids, or gases, gas pressure, liquid or gas flow rates, light or audio spectral emissions, and viscosity. For example, the temperature and viscosity of a liquid may be recorded in a liquid by combining a thermocouple with a vibrating ceramic resonator in the device. The mass loading of the resonator in the liquid may be used to measure viscosity.

In addition, devices constructed according to embodiments of the present invention may also be used to enhance worker safety. If attached to a worker's hand, arms or legs, such devices may be used to sense dangerous conditions and warn the worker. An example is a temperature sensor, which may accumulate data on heat exposure and provide the worker with advanced warning of heat exhaustion.

Devices constructed according to embodiments of the present invention may be used to provide auto routing of materials and subassemblies through automated workflow systems. Smart labels constructed according to an embodiment of the present invention may, for example, be attached to an unpopulated circuit board. Such a smart label may be programmed to direct the board through the automated workflow system. At each work station or parts station, such a label may communicate to the localized station device the parts or work that is required at that station in order to properly sequence that particular stage of production. This would provide a self-organizing factory that may produce a variety of products based upon the autonomous capabilities of the smart devices to work independently throughout the system finding its way to the correct workstations in the proper sequence without external system support.

In the context of environmental monitoring, the low cost and ease of development of devices constructed according to an embodiment of the present invention may enable and make economical environmental monitoring on a wide scale. Embodiments of the present invention may be used to create a variety of sense, store and report devices, which may be adhered to inside and outside objects to monitor and report environmental conditions. Using sensor technologies (e.g., fiber optics doped with reactive reagents) that may identify very small concentrations of pollutants in the air or water, devices constructed according to the present invention may be created that merge the sensors with microprocessors, memory, and RF transceivers. These devices may be programmed to form self-organizing networks, which may report their measurements to local transceivers linked to PCs that, in turn, may convey the information via the internet to users worldwide. Similar linkages to devices constructed according to an embodiment of the present invention may monitor and report air temperature, wind speed and direction, humidity and air pressure and density and act as very inexpensive localized weather reporting stations. The increased density of information gathered from the widespread application of weather reporting stations employing embodiments of the present invention may improve weather reporting and forecasting.

In the fashion, novelty and entertainment contexts, devices using the present invention may be used to create new types of smart game cards that would enable new types of game sets. Such devices may be incorporated into labels, pins, or jewelry, which may exhibit entertaining responses to certain conditions. For example, pairs of pins may be fabricated with devices that exhibited a smiley face symbol only in the presence of that certain other person. Such devices may be created with proximity RF devices and logic filters and LCD displays embedded in device. Similar devices may be attached to clothing, hats and other wearable items. Devices employing the present invention may be used to create new categories of toys. For example, a label may be attached to gambling chips so that casino managers may track and record their activity and movement through gaming operations.

Embodiments of the present invention may also be used to improve sports and sporting equipment. Devices employing embodiments of the present invention may enable and make economic a broad spectrum of measurement, sensing and machine intelligent devices that may enhance the performance of sporting equipment, bring added pleasure to sports, and make sports safer. Examples include devices with embedded strain gauges, accelerometers, and air velocity measuring components may be attached to golf clubs, tennis rackets, baseball bats and other sports equipment to accurately measure and record and report motion, so that feedback which may be provided to the user to perfect their “swing” or use of the sports equipment. In addition, devices with embedded accelerometers may be created that would attach to various helmets worn by sports participants that may record the severity of collisions (car crashes, football hits, etc) and thus assist sports medicine providers by reporting the severity and number of hits. Alerting officials of excessive repetitive acceleration of the head accomplished through the use of similar devices attached directly to the head of boxers may assist in preventing brain damage. Such devices attached to the body may record the build up of body temperature and alert athletes and officials of impending heat stroke or heat exhaustion. Devices containing accelerometers may be attached to key points on the body to help coaches and sports researchers investigate the motions exhibited by superior athletes. Such devices may also be attached to sporting equipment motors, which would record usage patterns and automatically signal required maintenance. Such devices may be attached to guns to alert of overheating during repeated use or record the number of fires for maintenance and cleaning. Devices using accelerometers and stain gauges combined with LCD displays may be attached to running shoes that would record the impact on the runners feet at each step and cumulatively. In this arrangement, the runner may be informed of the stress placed on his feet, knees, hip joints, and legs. The present invention may also enable the comparison of various shoes.

Embodiments of the present invention may also be used in the context of organizing physical objects. Libraries, warehouses, and distribution centers may use devices employing an embodiment of the present invention to automate the organization and regulate and control the use of books, CDs, packages, inventory items, and other physical objects. Libraries may attach devices employing embodiments of the present invention to books and other lent items, and such tags may contain microprocessors, memory, LCDs, batteries, charging methods (including solar and inductive), timers, RF, infrared, acoustic, or HAL effect communication ports and/or transceivers. Such a use of the present invention may facilitate automated check-out, wherein the user's library card would contain a smart device, each book and item would have an attached smart label or tag. The check-out station may contain interface and communication devices linked to the library's computer system, which may communicate to similar communication links embedded in the user's card and the item's tag. At the check-out station, the book or item may strobe (communicate to or with) the library system interface and the user's library card would be accessed and its identification recorded along with the identification of the item. The item's tag may then record the due date. The LCD display on the item's tag may from then on indicate the due date. As the due date approached, the LCD display may alternately turn on and off indicating the need to return the item.

Embodiments of the present invention may also facilitate automated return to the library. For example, upon returning the item to the library the user may elect to place the item at the check-in station or to file the item in its correct position. In the instance of filing the object, the user would follow instructions and directions illustrated on the LCD display of the item's tag in order to return it to its correct position in the Library. The sequence to accomplish this may be triggered by a strobe to the item's tag at the check-in station, and further strobed by localized transceivers located throughout the library. Library workers may check the inventory of items by using a portable transceiver strobing device. As the worker walked through the facility each item may communicate with the portable device. This device may, in turn, transfer the collected data to the library's computer system and thus accomplish a physical inventory of the library with a minimum of work. The library item tag's batteries may be recharged through inductive coils embedded in the library shelves, or by solar cells in brightly lit facilities.

Similar technical approaches combined with devices constructed according to the present invention may be used to organize and manage distribution, warehouse and other operations, which have to deal with a constantly changing physical inventory.

In the context of autos, trucks, buses and other transportation equipment, devices employing an embodiment of the present invention may be created that offer a wide variety of instrumentation and smart devices that may be attached to and measure the performance and condition of transportation vehicle components. The low cost and ease of installation of devices employing the present invention may make economic applications in this sector that are not affordable given conventional electronic packaging technologies. These devices include, but are not limited to: brake line integrity sensors and reporting devices, tire temperature and pressure devices, fuel leak detectors, strain gauges and acoustical devices used to detect impending stress failure, devices used to measure the performance of vehicle chassis during collisions and accidents, a variety of motor performance measures, pollution emissions detectors, and independent mileage recording devices. In addition, devices constructed according to the present invention may be attached to transportation vehicle batteries to monitor and illustrate or report their condition.

In the education context, devices employing embodiments of the present invention may be used to create a new category of education tools and learning aids. Examples include self-scoring tests and simulation devices, which may illustrate the behavior in the physical plane of abstract concepts. For example, models of the chemical elements may be created with attached devices employing an embodiment of the present invention, which may demonstrate the reactive and non-reactive properties of various combinations of elements. As the student combined the physical models, LCD displays may indicate the respective outcome. Similar technical approaches may illustrate electronic logic rules, or operational amplifier engineering. Student handouts and books may contain specialized and dedicated calculating devices constructed according to an embodiment of the present invention which may be used to augment the text portion of the publication.

Embodiments of the present invention may also be used in the law enforcement and security context. Because of their low cost, thin construction, low power requirements, and capability of being adhered to almost any object, embodiments of the present invention may enable a new category of security and law enforcement devices. Such devices may be used to make smart parking tickets that fined the offender based, not upon the occurrence, but rather on the time period during which the illegal parking spanned. Smart labels disguised as ordinary bumper stickers may be used to track stolen vehicles. Other similar disguised smart labels may be attached to valuable equipment or other property that may be used to track and identify such items after theft. A variety of acoustic, RF proximity, and infrared sensors may be created with devices that may detect intrusions and break-ins. Devices employing the present invention may also be attached to police sticks that would record the force used to subdue suspects.

In the retail operations context, devices employing the present invention may be used to control and monitor store inventory using similar technical approaches cited above as described with reference to organizing physical objects. Such devices may also be used to refine store logistics as cited above in the section describing transportation and logistics. In addition, such devices may be used to create dynamic pricing labels, which may modify prices of items on command or grant special discounts to certain preferred customers. In this instance, the preferred customer may swipe the items pricing label on the shelf in the store and see the special discount displayed on the LCD price label indicator. The smart label may also assist the management of returned items, and in some instances automate the process of in store returns.

Devices employing embodiments of the present invention may also be used in a variety of applications to improve agricultural operations. Such applications include the capability to measure the performance and monitor the condition of the vast array of agricultural machinery used in modern agricultural practice. In these applications, similar technologies may be used as in the section above describing application of the present invention to transportation equipment. In addition, devices employing embodiments of the present invention may be used to monitor soil conditions over the landscape of farms. These devices may be adhered to wooden or metal stakes driven in the ground. LCD visual displays or RF transmission components may communicate the changing soil conditions to the farmer. Devices employing embodiments of the present invention may also be used to monitor, record and report the condition and moisture content of stored crops and fertilizer.

In the military context, embodiments of the present invention may be used to improve, speed the development, and lower the costs of achieving our military's goal of using information age tools to improve our war fighting capability. Almost all of the uses of the devices described above are applicable to military use. These applications share the same functions as described above in the sections about medical devices, logistics and transportation organization, and monitoring the condition and performance of equipment. Military applications of the present invention also include that the capabilities and functions mentioned above be applied to war fighting machines—tanks, artillery, guns and machine guns, and other weapons. Additional specialized military functions may include the monitoring, recording and reporting of battlefield conditions. For example, smart wireless proximity sensors to report the presence of the enemy at certain locations, sensors used to detect and signal the release of chemical or biological weapons, stick-on tags for soldiers to measure and report their health and life condition in combat conditions so care givers may prioritize their operations on the battlefield, and add-on fuses to mines and other weapons to enable new sensors to be used on old weaponry.

The present invention may also be used in the context of scientific, developmental, and consumer research. The ability to produce quickly (and at very low cost) unique measurement devices one at a time or at very low production levels may enable researchers to assemble and use new sets of measurement devices using embodiments of the present invention, which may not be economic or timely using conventional technology. Simple examples include strain gauges applied to telescope mirrors to detect optical warping, reporting gauges adhered to furniture to record consumers reactions to TV advertisement. In the laboratory setting, embodiments of the present invention may enable a rapid modification of measurement systems to perfect experimental procedures. In the field, because of the capability to place devices employing the present invention in operation quickly, and because placement is so flexible (i.e., the devices may be adhered to almost any object), experiments may be done rapidly and modified quickly.

It will be appreciated that modifications and variations of these examples are covered by the teachings provided and are within the purview of the appended claims.

What is claimed is:

1. An apparatus comprising:
a first layer comprising a non-conductive adhesive region and a conductive adhesive region;
a second layer coupled to the first layer, the second layer comprising an electronic component, wherein the electronic component is in electrical connection to the conductive adhesive region in the first layer so that the conductive adhesive region provides a contact point for the electronic component; and
a third layer coupled to the second layer, the third layer comprising an adhesive to couple the apparatus to an object.

2. The apparatus of claim 1, wherein the apparatus further comprises a forth layer coupled to the third layer to substantially cover the third layer, the forth layer being releasably removable from the third layer.

3. The apparatus of claim 1, wherein the thickness measured from the first layer to the third layer is less than 1.5 millimeters.

4. The apparatus of claim 1, wherein the apparatus has a flex radius of 0.1 inches.

5. The apparatus of claim 1, wherein the component in the second layer is one of a plurality of types, and wherein the first layer comprises a plurality of conductive adhesive regions arranged in a geometric pattern that corresponds to the component type of the component in the second layer.

6. The apparatus of claim 1, wherein the second layer further comprises a substrate.

7. The apparatus of claim 1, wherein the apparatus further comprises a conductive non-adhesive region to provide an additional contact point for the electronic component.

8. A system comprising a plurality of modules, wherein each module comprises a component layer and an adhesive layer, wherein each component layer comprises an electronic component, wherein each adhesive layer comprises a non-conductive adhesive region and a conductive adhesive region, wherein the electronic component in each module is in electrical connection with the conductive adhesive region in that module, and wherein the adhesive layer in a first module of the plurality of modules is coupled the adhesive layer in a second of the plurality of modules so that the conductive adhesive region in the first module is coupled to the conductive adhesive region in the second module to create an electrical path between the electronic component in the first module and the electronic component in the second module.

9. The system of claim 8, wherein each component layer further comprises a flexible substrate.

10. The system of claim 9, wherein if the system is adhered to an object the system thickness measured from the object to the farthest part of the system from that object is less than 0.5 millimeters.

11. The system of claim 10, wherein the system has a flex radius of 0.1 inches.

12. The system of claim 11, wherein one of said modules is a central processing unit module, one of said modules is a power module, and one of said modules is a sensor.

13. A method of constructing a circuit, the method comprising:
remove a releasable cover from a first module, wherein removing the cover exposes at least part of an adhesive layer of the first module, wherein the adhesive layer contains regions of conductive and non-conductive material, and wherein the first module contains a first electronic component;
remove a releasable cover from a second module, wherein removing the cover exposes at least part of an adhesive layer of the second module, wherein the adhesive layer contains regions of conductive and non-conductive material, and wherein the second module contains a second electronic component; and
adhering the second module to the first module, wherein adhering includes connecting conductive regions in the adhesive layer of the first module with conductive regions in the adhesive layer of the second module to form an electrical connection between the electronic component in the first module and the electronic component in the second module.

14. The method of claim 13, wherein the first module further comprises an additional conductive region, and wherein the method further comprises:
coupling contacts to the additional conductive region in the first module, wherein the contacts are coupled to a computer device;
downloading programming information from the computer device to the electronic component in the first module; and
uncoupling the contacts from the first module.

15. The method of claim 13, wherein method further comprises:
removing only a portion of a releasable cover from a third module, wherein removing the portion of the cover exposes a portion of an adhesive layer of the third module, wherein the adhesive layer contains regions of conductive and non-conductive material, and wherein the third module contains a third electronic component; and
adhering the exposed portion of the adhesive layer of the third module to the adhesive layer of the first module, wherein adhering includes connecting conductive regions in the adhesive layer of the third module to conductive regions in the adhesive layer of the first module to form an electrical connection between the electronic component in the third module and the electronic component in the first module.

16. The method of claim 13, wherein the removing and adhering are performed by an automated manufacturing device.

17. A method of processing data related to an object, wherein the method comprises:
removing a releasable cover from a device to expose at least part of an adhesive layer, wherein the device comprises an electronic component;
coupling the device to an object using the adhesive layer; and
processing data in the electronic component, wherein the data is related to the object or related to the environment the object is in.

18. The method of claim 17, wherein coupling the device includes flexing the device to conform to shape of the object.

19. The method of claim 18, wherein the device has a thickness of less than 0.5 millimeters.

20. The method of claim 17, wherein processing data comprises:
sensing data in a sensor module of the device; and
transmitting the data using an interface in the device.
